(19) United States
(12) Patent Application Publication
(10) Pub. No.: US 2010/0265234 A1
(43) Pub. Date: Oct. 21, 2010

(54) Driver and display apparatus using the same

(75) Inventor: Motoo Fukuo, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/662,358

(22) Filed: Apr. 13, 2010

(30) Foreign Application Priority Data
Apr. 21, 2009 (JP) 2009-102853

(51) Int. Cl. G09G 5/00

(52) U.S. Cl. 345/211

(57) ABSTRACT

A driver includes a gradation voltage supplying section configured to supply a first output gradation voltage to a data line in a first display period; and a charge share performing section configured to supply a second voltage between the first output gradation voltage and a first voltage to the data line in a charge share period after the first display period. The first voltage is a common voltage between the first output gradation voltage and a second output gradation voltage of a polarity opposite to that of the first output gradation voltage.

### INCORPORATION BY REFERENCE

This application claims a priority on convention based on Japanese Patent Application No. 2009-102853. The disclosure thereof is incorporated herein by reference.

### TECHNICAL FIELD

The present invention relates to a driver for driving a display panel to display a data and a TFT (Thin Film Transistor) liquid crystal display (LCD) device.

### BACKGROUND ART

A TFT liquid crystal display device is spreading widely. The TFT liquid crystal display device includes a display section and a driver for driving the display section. The display section includes data lines. The driver selects output gradation voltages from among a plurality of gradation voltages in one horizontal period based on display data and supplies the selected output gradation voltages to the data lines. The TFT liquid crystal display device employs a liquid crystal panel as the display section. Thus, in order to prevent degradation of image quality of the display section, the TFT liquid crystal display device adopts a driving system in which a polarity of the output gradation voltages is inverted by the driver for every horizontal period. The driving system of this type is called a one-line inversion driving system. The one-line inversion driving system is described in Japanese Patent Publications (JP 2001-515225A and JP 2007-52396A).

According to the one-line inversion driving system, the driver alternately supplies a first output gradation voltage and a second output gradation voltage to the data line for every horizontal period. The second output gradation voltage is a voltage of a polarity opposite to that of the first output gradation voltage. One horizontal period includes a display period and a charge share period. The charge share period is a period between one display period and a next display period, and is far shorter than one display period. In one display period and the next display period, the driver supplies the first and second output gradation voltages to the data line, respectively. In the charge share period, the driver supplies a common voltage between the first output gradation voltage and the second output gradation voltage to the data lines.

In this way, according to the one-line inversion driving system, the driver inverts the polarity of the output gradation voltage for every horizontal period, and it is possible to prevent degradation of image quality of the display section. On the other hand, since the driver alternately supplies the first or second output gradation voltage and the common voltage to the data line in one horizontal period, a power consumption amount when driving the display section increases as the display section is made larger in size.

However, it is sometimes necessary to perform reduction of the power consumption amount with a higher priority than prevention of the degradation of image quality.

### Citation List:

Patent literature 1: JP 2001-515225A

Patent literature 2: JP 2007-52396A

### SUMMARY OF THE INVENTION

In an aspect of the present invention, a driver includes a gradation voltage supplying section configured to supply a first output gradation voltage to a data line in a first display period; and a charge share performing section configured to supply a second voltage between the first output gradation voltage and a first voltage to the data line in a charge share period after the first display period. The first voltage is a common voltage between the first output gradation voltage and a second output gradation voltage of a polarity opposite to that of the first output gradation voltage.

In another aspect of the present invention, a display apparatus includes a driver; and a display section. The driver includes a gradation voltage supplying section configured to supply a first output gradation voltage to a data line in a first display period; and a charge share performing section configured to supply a second voltage between the first output gradation voltage and a first voltage to the data line in a charge share period after the first display period. The first voltage is a common voltage between the first output gradation voltage and a second output gradation voltage of a polarity opposite to that of the first output gradation voltage.

In still another aspect of the present invention, a driving method is achieved by supplying a first output gradation voltage to a data line in a first display period, wherein a first voltage is a common voltage between the first output gradation voltage and a second output gradation voltage of a polarity opposite to that of the first output gradation voltage; and by supplying a second voltage between the first output gradation voltage and the first voltage to the data line in a charge share period after the first display period.

According to the present invention, the reduction of the power consumption amount is performed over the prevention of the degradation of image quality, by adopting a plural-line inversion driving system. Also, one of the one-line inversion driving system and the plural-line inversion driving system is selected based on the customer's request.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram schematically showing a configuration of a TFT liquid crystal display apparatus 1 according to an embodiment of the present invention;

FIG. 2 is a block diagram schematically showing a configuration of a source driver of the TFT liquid crystal display apparatus according to the embodiment of the present invention;

FIG. 3 is a circuit diagram showing a configuration of an instructing section of the source driver in the TFT liquid crystal display apparatus according to the embodiment of the present invention;

FIG. 4 is a circuit diagram showing a configuration of a charge share performing section of the source driver in the TFT liquid crystal display apparatus according to the embodiment of the present invention;

FIG. 5 shows timing charts of an operation of the instructing section of the source driver in the TFT liquid crystal display apparatus according to the embodiment of the present invention;

FIG. 6 shows timing charts of an operation of the charge share performing section of the source driver in the TFT liquid crystal display apparatus according to the embodiment of the present invention;

FIG. 7 shows timing charts of an operation of the TFT liquid crystal display apparatus according to the embodiment of the present invention in a plural-line inversion driving system;

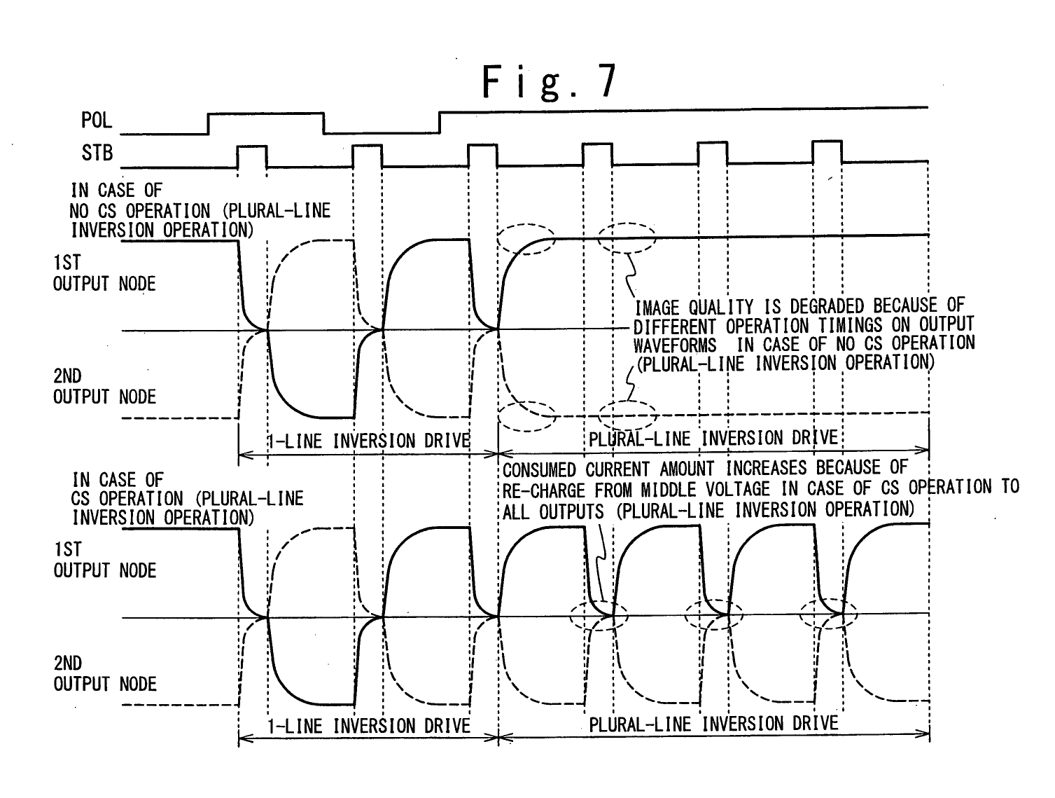

FIG. 8 is a circuit diagram showing a configuration of the instructing section of the source driver of the TFT liquid crystal display apparatus according to another embodiment of the present invention;

FIG. 9 is a circuit diagram showing a configuration of the instructing section of the source driver of the TFT liquid crystal display apparatus 1 according to yet another embodiment of the present invention; and

FIG. 10 is a circuit diagram of a configuration of the instructing section of the source driver of the TFT liquid crystal display apparatus 1 according to still another embodiment of the present invention.

### DESCRIPTION OF EMBODIMENTS

Hereinafter, a TFT (Thin Film Transistor) liquid crystal display (LCD) device to which a driver according to the present invention is applied will be described in detail with reference to the attached drawings.

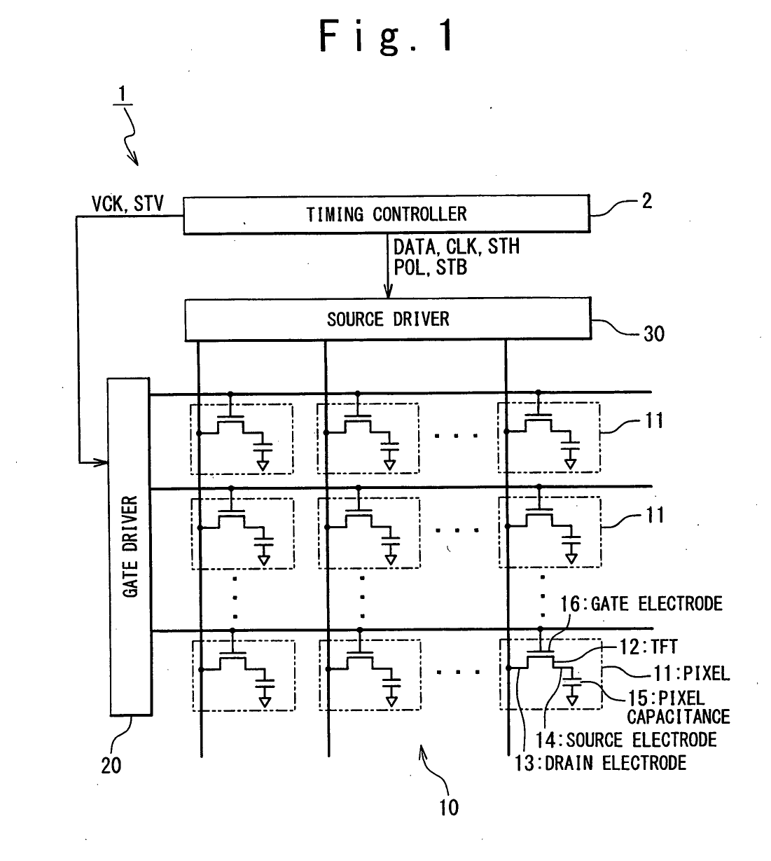

FIG. 1 shows a configuration of a TFT liquid crystal display apparatus 1 according to one embodiment of the present invention. Referring to FIG. 1, the TFT liquid crystal display apparatus 1 according to the embodiment of the present invention includes a display section (liquid crystal panel) 10 as an LCD (Liquid Crystal Display) module. The liquid crystal panel 10 includes a plurality of pixels 11 arranged in a matrix. Each of the pixels 11 includes a thin film transistor (TFT) 12 and a pixel capacitance 15. The pixel capacitance 15 includes a pixel electrode and a counter electrode opposing to the pixel electrode. The TFT 12 includes a drain electrode 13, a source electrode connected to the pixel electrode, and a gate electrode 16.

The TFT liquid crystal display apparatus 1 according to the embodiment of the present invention also includes a plurality of gate lines and a plurality of data lines. Each of the gate lines is connected to gate electrodes 16 of the TFTs 12 of the pixels 11 provided in one row. Each of the plurality of data lines is connected to drain electrodes 13 of the TFTs 12 of the pixels 11 provided in one column.

The TFT liquid crystal display apparatus 1 according to the embodiment of the present invention also includes a gate driver 20 and a source driver 30 as drivers for driving the plurality of pixels 11 of the liquid crystal panel 10. The gate driver 20 is provided on a chip or substrate (not shown) and connected to the plurality of gate lines. The source driver 30 is provided on the chip or substrate and connected to the plurality of data lines.

The TFT liquid crystal display apparatus 1 according to the embodiment of the present invention further includes a timing controller 2. The timing controller 2 is provided on a chip or substrate.

The timing controller 2 outputs a vertical clock VCK and a vertical shift pulse signal STV for sequentially selecting first to last gate lines in one horizontal period. For example, it is assumed that the gate driver 20 selects one of the plurality of gate lines in response to the vertical shift pulse signal STV and the vertical clock signal VCK. In this case, the gate driver 20 outputs a selection signal to one gate line. This selection signal is supplied to gate electrodes 16 of the TFTs 12 of the pixels for the selected gate line, and the TFTs 12 are turned on in response to the selection signal. The same operation is applied to the other gate lines.

The timing controller 2 outputs a frame display data DATA for one frame, a clock signal CLK, and a shift pulse signal STH to the source driver 30. The frame display data DATA for one frame includes a plurality of line display data from first to last horizontal lines. The line display data for one line includes a plurality of display data for the plurality of data lines. The source driver 30 outputs the plurality of display data to the plurality of data lines in response to the shift pulse signal STH and the clock signal CLK. At this time, the TFTs 12 of the pixels 11 for one of the plurality of gate lines and the plurality of source lines are turned on. Thus, the plurality of display data are written into the pixel capacitances 15 of the pixels 11 and held until next write operation. As a result, the line display data for one line is displayed.

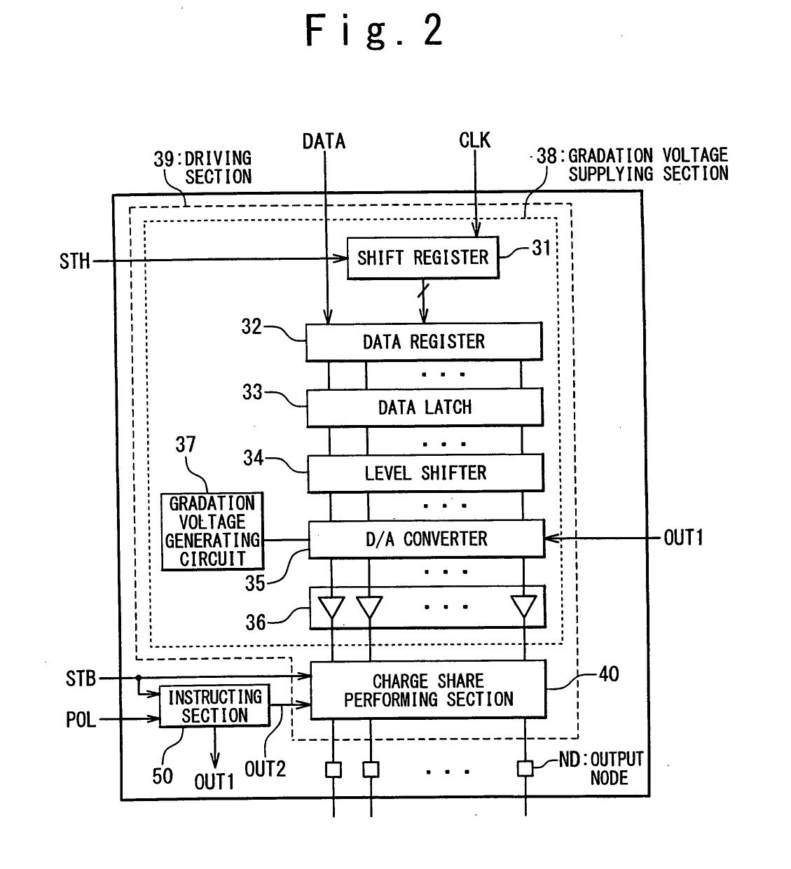

FIG. 2 shows a configuration of the source driver 30. The source driver 30 includes a driving section 39 and a plurality of output nodes NDs. The plurality of output nodes NDs are connected to the plurality of data lines, respectively. The driving section 39 includes a gradation voltage supplying section 38. The gradation voltage supplying section 38 includes a shift register 31, a data register 32, a data latch circuit 33, a level shifter circuit 34, a D/A converter circuit 35, an output buffer circuit 36, and a gradation voltage generating circuit 37.

The gradation voltage generating circuit 37 includes gradation resistance elements connected in series. This gradation voltage generating circuit 37 divides a voltage between reference voltages from a power supply circuit (not shown) into a plurality of gradation voltages by the gradation resistance elements, and outputs the plurality of gradation voltages.

The shift register 31 sequentially shifts the shift pulse signal STH in synchronization with the clock signal CLK and outputs the shifted shift pulse signal STH to the data register 32. The data register 32 acquires the plurality of display data (line display data) from the timing controller 2 in synchronization with the shift pulse signal STH from the shift register 31, and outputs the display data to the data latch circuit 33.

The data latch circuit 33 includes a plurality of data latches. The plurality of data latches latch the plurality of display data from the shift register 32 at same timing, and outputs the latched line display data to the level shifter circuit 34.

The level shifter circuit 34 includes a plurality of level shifters. The plurality of level shifters converts levels of the line display data supplied from the data latch circuit 33, and outputs the level-converted digital line display data to the D/A converter circuit 35.

The D/A converter circuit 35 includes a plurality of D/A converters. The plurality of D/A converters convert the digital line display data supplied from the level shifter circuit 34 into analog line display data. That is, each of the plurality of D/A converters selects an output gradation voltage from among a plurality of gradation voltages based on the display data, and outputs the selected output gradation voltage to the output buffer circuit 36.

The output buffer circuit 36 includes a plurality of buffers. Outputs from the plurality of buffers are connected to the plurality of data lines via the plurality of output nodes NDs, respectively. The plurality of buffers outputs the output gradation voltages to the plurality of data lines, respectively.

A driving system of the source driver 30 is switched based on the specification. In this case, the source driver 30 is used according to one of first and second specifications. In the first specification, the source driver 30 adopts a one-line inversion driving system as a first driving system. In the second specification, the source driver 30 adopts a plural-line inversion driving system as a second driving system.

To realize this switching, the source driver 30 further includes an instructing section 50. The driving section 39 further includes a charge share performing section 40. The instructing section 50 is connected to the gradation voltage supplying section 38 and the charge share performing section 40 of the driving section 39. The charge share performing section 40 is connected between the output buffer circuit 36 of the gradation voltage supplying section 38 and the plurality of output nodes NDs. The instructing section 50 and the charge share performing section 40 will be described later.

Furthermore, the gradation voltage generating circuit 37 generates a plurality of positive polarity gradation voltages and a plurality of negative polarity gradation voltages. The plurality of negative polarity gradation voltages are voltages opposite in polarity to the plurality of positive polarity gradation voltages. Further, the timing controller 2 outputs a polarity inversion signal POL for instructing polarity inversion in accordance with the first or second specification and a strobe signal STB to the source driver 30.

It is assumed herein that a first group is of odd-numbered data lines of the plurality of data lines and a second group is of even-numbered data lines thereof. The data lines of the first and second groups are connected to output nodes NDs of first and second groups among the plurality of output nodes NDs, respectively. In this case, it is assumed that odd-numbered display data of the plurality of display data are for an odd-number column of the odd-numbered data lines and even-numbered display data of the plurality of display data are for an even-number column of the even-numbered data lines.

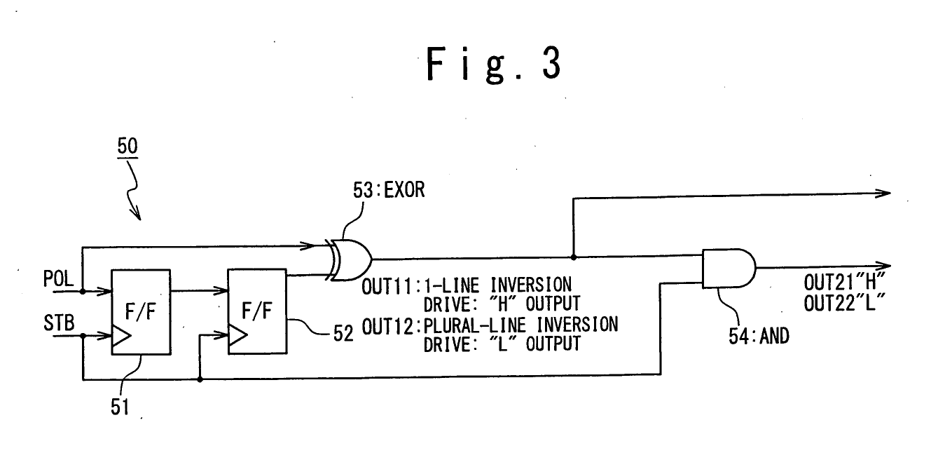

FIG. 3 shows a configuration of the instructing section 50. The instructing section 50 includes flip-flops 51 and 52, an exclusive-OR (EXOR) circuit 53, and an AND circuit 54. The polarity inversion signal POL is supplied to an input of the flip-flop 51 and the strobe signal STB is supplied to a clock input of the flip-flop 51. An output from the flip-flop 51 is supplied to an input of the flip-flop 52 and the strobe signal STB is supplied to a clock input of the flip-flop 52. The polarity inversion signal POL and an output from the flip-flop 52 are supplied to inputs of the EXOR circuit 53. An output from the EXOR circuit 53 is connected to the DA converter 53. Also, the output from the EXOR circuit 53 and the strobe signal STB are supplied to inputs of the AND circuit 54. The AND circuit 54 outputs a signal OUT21 or OUT22 to the charge share performing section 40.

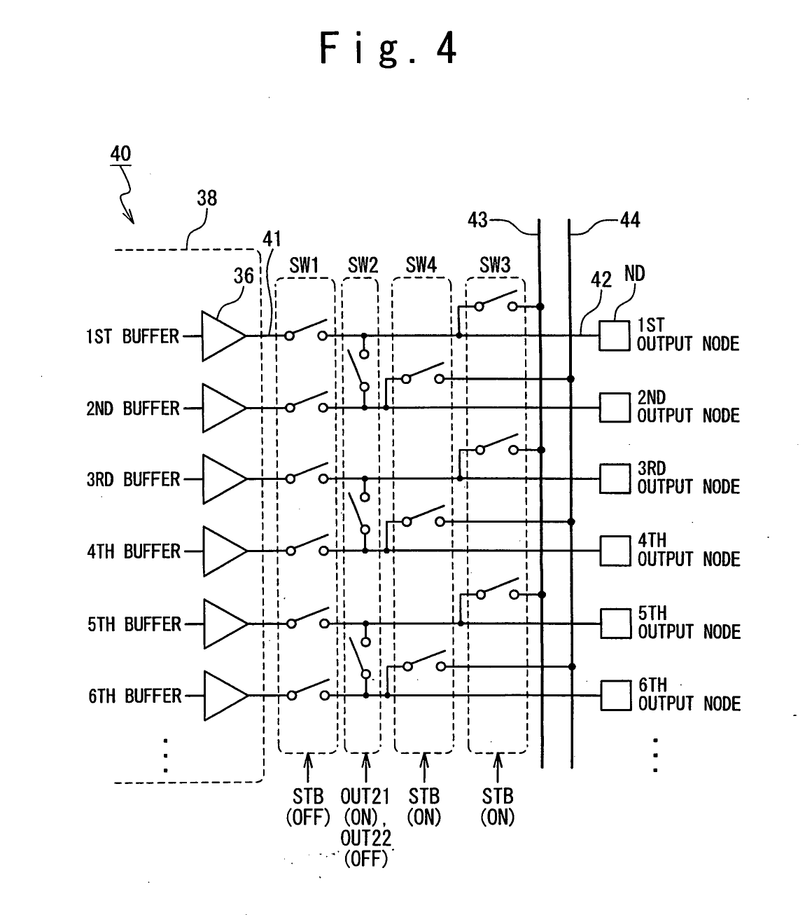

FIG. 4 shows a configuration of the charge share performing section 40. The charge share performing section 40 includes a plurality of interconnections 41, a plurality of interconnections 42, a first short-circuit line (hereinafter, “short-circuit line”) 43, a second short-circuit line (hereinafter, “short-circuit line”) 44, a first switch section, a second switch section, a third switch section, and a fourth switch section. The plurality of interconnections 41 are connected to the plurality of output buffers of the output buffer circuit 36 and the plurality of output nodes NDs, respectively. The short-circuit lines 43 and 44 are provided to short-circuit the first and second groups of data lines, respectively.

The first switch section includes a plurality of switches SW1. The plurality of interconnections 41 are connected to the plurality of output buffers of the output buffer circuit 36 and the plurality of switches SW1, respectively. The plurality of interconnections 42 are connected to the plurality of switches SW1 of and the plurality of output nodes NDs, respectively. The strobe signal STB is supplied to the plurality of switches SW1. The plurality of switches SW1 are turned on when a signal level of the strobe signal STB is high “H”.

The second switch section includes a plurality of switches SW2. The plurality of switches SW2 are connected to the first, third, fifth, . . . interconnections 42 that are the odd-numbered interconnections 42 and the second, fourth, sixth, . . . interconnections 42 that are the even-numbered interconnections 42, respectively. The output from the AND circuit 54 included in the instructing section 50 is supplied to the plurality of switches SW2. The plurality of switches SW2 are turned on when the output from the AND circuit 54 is high level “H”.

The third switch section includes a plurality of switches SW3. The plurality of switches SW3 are connected to the first, third, fifth, . . . interconnections 42, respectively, and also connected to the short-circuit line 43. The strobe signal STB is supplied to the plurality of switches SW3. The plurality of switches SW3 are turned on when the signal level of the strobe signal STB is high “H”.

The fourth switch section includes a plurality of switches SW4. The plurality of switches SW4 are connected to the second, fourth, sixth, . . . interconnections 42, respectively, and also connected to the short-circuit line 44. The strobe signal STB is supplied to the plurality of switches SW4. The plurality of switches SW4 are turned on when the signal level of the strobe signal STB is high “H”.

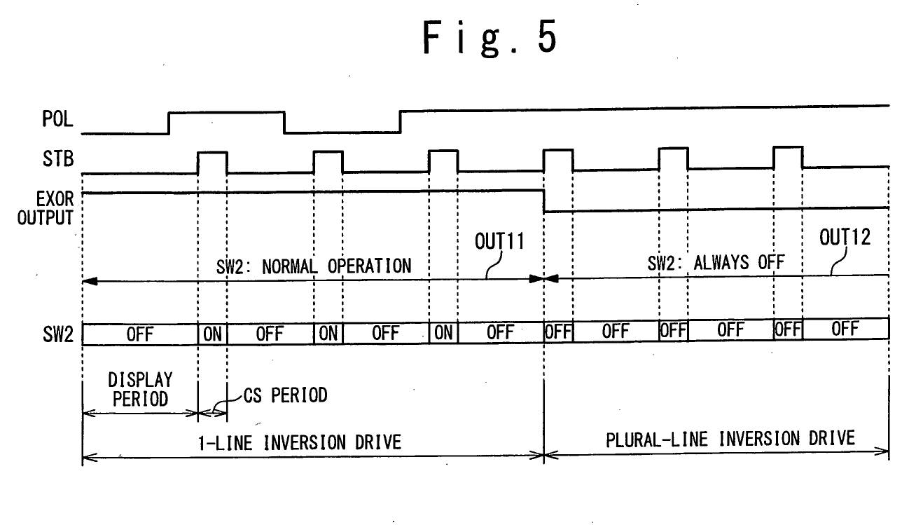

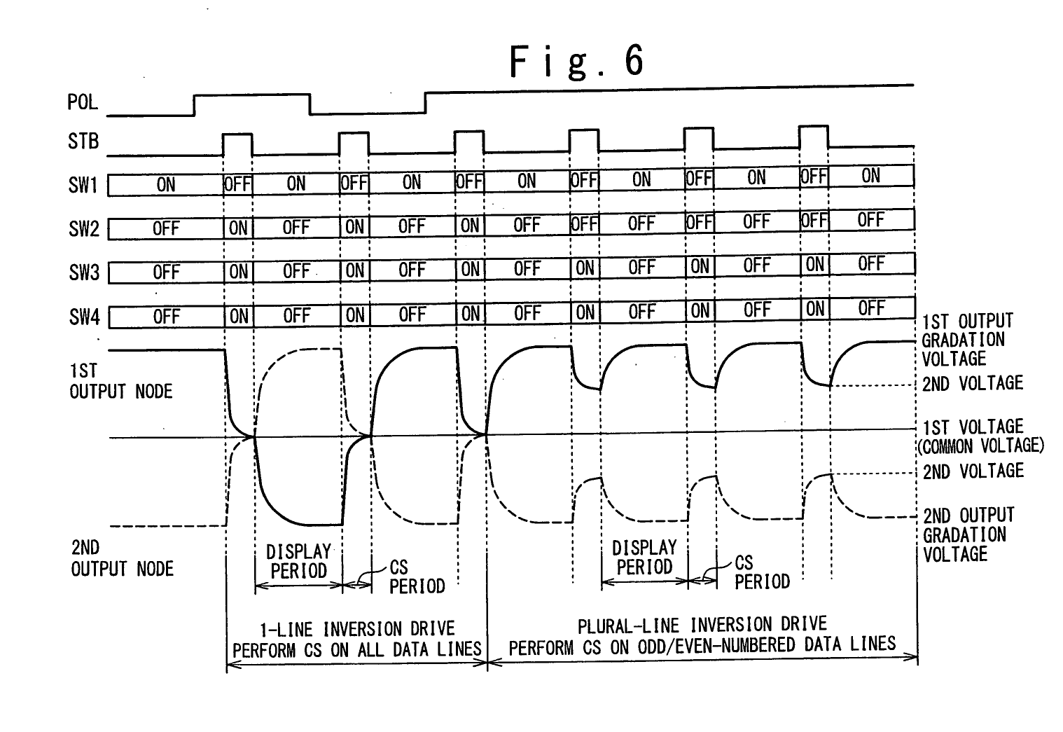

An operation of the TFT liquid crystal display apparatus 1 according to the embodiment of the present invention will next be described. FIG. 5 shows timing charts of an operation of the instructing section 50. FIG. 6 shows timing charts of an operation of the charge share performing section 40.

### (One-Line Inversion Driving System)

If the polarity inversion signal POL represents the first specification, the polarity inversion signal POL alternately takes a low level “L” and a high level “H” for every horizontal period. One horizontal period includes a display period and a charge share (hereinafter, “CS”) period. The charge share period is a period between a display period and a next display period and far shorter than one display period. The strobe signal STB takes a high “H” in the CS period.

The instructing section 50 outputs a first control signal based on the polarity inversion signal POL and the strobe signal STB so as to control the driving section 39 to execute the one-line inversion driving system. The first control signal includes control signals OUT11 and OUT21. The control signal OUT11 is always in a high level “H”, and the control signal OUT21 is in the high level “H” during the CS period. In this case, the D/A converter circuit 35 recognizes that the one-line inversion driving system is to be executed in response to the control signal OUT11.

In the display period, the strobe signal STB is in a low level “L”. At this time, the plurality of switches SW1 of the charge share performing section 40 are turned on in response to the strobe signal STB of “L” and connect the plurality of output buffers of the output buffer circuit 36 to the plurality of data lines via the plurality of output nodes NDs, respectively.

The D/A converter circuit 35 selects first output gradation voltages from among the plurality of positive polarity gradation voltages based on the odd-numbered display data, and outputs the selected first output gradation voltages to the first, third, fifth, . . . output buffers that are the odd-numbered output buffers among the plurality of output buffers of the output buffer circuit 36. The first, third, fifth, . . . output buffers supply the first output gradation voltages to the data lines of the first group via the charge share performing section 40 and the output nodes NDs of the first group, respectively.

The D/A converter circuit 35 selects second output gradation voltages from among the plurality of negative polarity gradation voltages based on the even-numbered display data, and outputs the selected second output gradation voltages to the second, fourth, sixth, . . . output buffers that are the even-numbered output buffers among the plurality of output buffers of the output buffer circuit 36. The second, fourth, sixth, . . . output buffers supply the second output gradation voltages to the data lines of the second group via the charge share performing section 40 and the output nodes NDs of the second group, respectively.

In the next display period, the strobe signal STB is in the low level “L” similarly to the preceding display period. At this time, the plurality of switches SW1 of the charge share performing section 40 are turned on in response to the strobe signal STB of “L”, and connects the plurality of output buffers of the output buffer circuit 36 to the plurality of data lines via the plurality of output nodes NDs, respectively.

The D/A converter circuit 35 selects the second output gradation voltages from among the plurality of negative gradation voltages based on the odd-numbered display data and outputs the selected second output gradation voltages to the first, third, fifth, . . . output buffers of the output buffer circuit 36. The first, third, fifth, . . . output buffers supply the second output gradation voltages to the data lines of the first group via the charge share performing section 40 and the output nodes NDs of the first group, respectively. That is, the gradation voltage supplying section 38 inverts the polarity of the output gradation voltages and supplies the polarity-inverted output gradation voltages to the data lines of the first group.

The D/A converter circuit 35 selects the first output gradation voltages from among the plurality of positive gradation voltages based on the even-numbered display data and outputs the selected first output gradation voltages to the second, fourth, sixth, . . . output buffers of the output buffer circuit 36. The second, fourth, sixth, . . . output buffers supply the first output gradation voltages to the data lines of the second group via the charge share performing section 40 and the output nodes NDs of the second group, respectively. That is, the gradation voltage supplying section 38 inverts the polarity of the output gradation voltages and supplies the polarity-inverted output gradation voltage to the data lines of the second group.

In the CS period between one display period and the next display period, the strobe signal STB is in a high level “H”. At this time, the plurality of switches SW1 of the charge share performing section 40 are turned off in response to the strobe signal STB of “H”, and disconnects the plurality of output buffers of the output buffer circuit 36 from the plurality of data lines, respectively. The plurality of switches SW 3 are turned on in response to the strobe signal STB of “H” and connects the first group of data lines to the short-circuit line 43, respectively. The plurality of switches SW4 are turned on in response to the strobe signal STB of “H” and connects the second group of data lines to the short-circuit line 44, respectively. In this way, the data lines of the first group are connected to the nodes NDs of the first group via the short-circuit line 43 by the plurality of switches SW3, respectively. In addition, the data lines of the second group are connected to the nodes NDs of the second group via the short-circuit line 44 by the plurality of switches SW4, respectively.

In the CS period, the control signal OUT21 is in the high level “H”. Thus, the plurality of switches SW2 are turned on in response to the control signal OUT21 of “H” and connects the data lines of the first group to the data lines of the second group, respectively. In this case, a common voltage (a first voltage) that is an intermediate voltage between the first and second output gradation voltages is supplied to the first and second groups of data lines.

In this manner, in the one-line inversion driving system, the driver 30 inverts the polarity of the output gradation voltages for every horizontal period, thereby making it possible to prevent degradation of image quality of the display section 10. On the other hand, since the driver 30 alternately supplies the first or second output gradation voltages and the common voltage (the first voltage) to the data lines in one horizontal period, power consumption at time of driving the display section 10 increases as the display section 10 is made large in size.

### (Plural-Line Inversion Driving System)

If the polarity inversion signal POL represents the second specification, the polarity inversion signal POL is always in the high level “H”. The plural-line inversion driving system will be described while an overlap portion with the one-line inversion driving system is not repeatedly described.

The instructing section 50 outputs a second control signal based on the polarity inversion signal POL and the strobe signal STB to control the driving section 39 to execute the plural-line inversion driving system. The second control signal includes control signals OUT12 and OUT22. The control signal OUT12 is always in the low level “L”. Thus, the plurality of switches SW1 of the charge share performing section 40 are turned on in response to the strobe signal STB of “L”, and connects the plurality of output buffers of the output buffer circuit 36 to the plurality of data lines via the plurality of output nodes NDs, respectively. The control signal OUT22 is always in the low level “L”.

In this case, the D/A converter circuit 35 recognizes that the plural-line inversion driving system is to be executed, based on the control signal OUT12. In one display period and the next display period, the D/A converter circuit 35 selects the first output gradation voltages from among the plurality of positive polarity gradation voltages based on the odd-numbered display data, and outputs the selected first output gradation voltages to the first, third, fifth, . . . output buffers that are the odd-numbered output buffers of the plurality of output buffers of the output buffer circuit 36. The first, third, fifth, . . . output buffers supply the first output gradation voltages to the data lines of the first group via the charge share performing section 40 and the output nodes NDs of the first group, respectively.

The D/A converter circuit 35 selects the second output gradation voltages from among the plurality of negative polarity gradation voltages based on the even-numbered display data, and outputs the second, fourth, sixth, . . . output buffers that are the even-numbered output buffers of the plurality of output buffers of the output buffer circuit 36. The second, fourth, sixth, . . . output buffers supply the second output gradation voltages to the data lines of the second group via the charge share performing section 40 and the output nodes NDs of the second group, respectively.

In the CS period between one display period and the next display period, the plurality of switches SW3 are turned on in response to the strobe signal STB of “H” and connects the data lines of the first group to the short-circuit line 43, respectively. The plurality of switches SW4 is turned on in response to the strobe signal STB of “H” and connects the data lines of the second group to the short-circuit line 44, respectively. Thus, the first group of data lines is connected to the short-circuit line 43 by the plurality of switches SW3, and the second group of data lines is connected to the short-circuit line 44 by the plurality of switches SW4.

In the CS period, the control signal 0UT22 is in the low level “L”. Thus, the plurality of switches SW2 are turned off in response to the control signal OUT22 of “L”. In this case, a second voltage between the first and second output gradation voltage and the first voltage is supplied to the first and second groups of data lines, respectively.

In this manner, in the plural-line inversion driving system, the driver 30 alternately supplies the first or second output gradation voltage and the second voltage to the data lines in one horizontal period without inverting the polarity of the output gradation voltages for every horizontal period. The second voltage is a voltage between the first or second output gradation voltage and the common voltage (the first voltage). Thus, it is possible to reduce a power consumption amount, while the deterioration of the image quality of the display section 10 is prevented to some extent, as compared with the one-line inversion driving system.

According to the TFT liquid crystal display device according to the embodiment of the present invention, when reduction of the power consumption amount is requested strongly, it is possible to satisfy the request by adopting a plural-line driving system. Also, if the TFT liquid crystal display apparatus 1 according to the embodiment of the present invention selectively uses one of the one-line inversion driving system and the plural-line inversion driving system based on a customer's request, the instructing section 50 outputs the first or second control signal, thereby making it possible to satisfy the customer's demand.

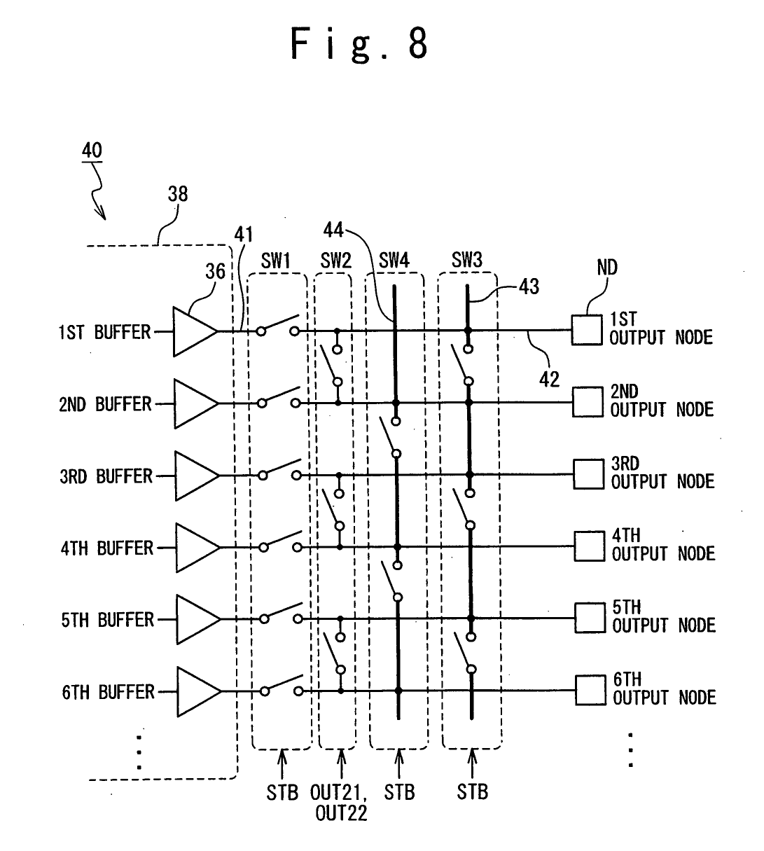

As shown in FIG. 8, the plurality of switches SW3 and the plurality of switches SW4 can be provided on the short-circuit lines 43 and 44, respectively. Specifically, the plurality of switches SW3 are provided on the short-circuit line 43 and connected to first, third, fifth, . . . interconnections 42, respectively. The plurality of switches SW4 are provided on the short-circuit line 44 and connected to second, fourth, sixth, . . . interconnections 42, respectively and also to the short-circuit line 44. In this case, in the CS period, the plurality of switches SW3 are turned on in response to the strobe signal STB of “H”, and connects the first group of data lines to the short-circuit line 43. The plurality of switches SW4 are turned on in response to the strobe signal STB of “H”, and connects the second group of data lines to the short-circuit line 44. The data lines of the first group are directly connected to the short-circuit line 43 by the plurality of switches SW3 and the data lines of the second group are directly connected to the short-circuit line 44 by the plurality of switches SW4, respectively.

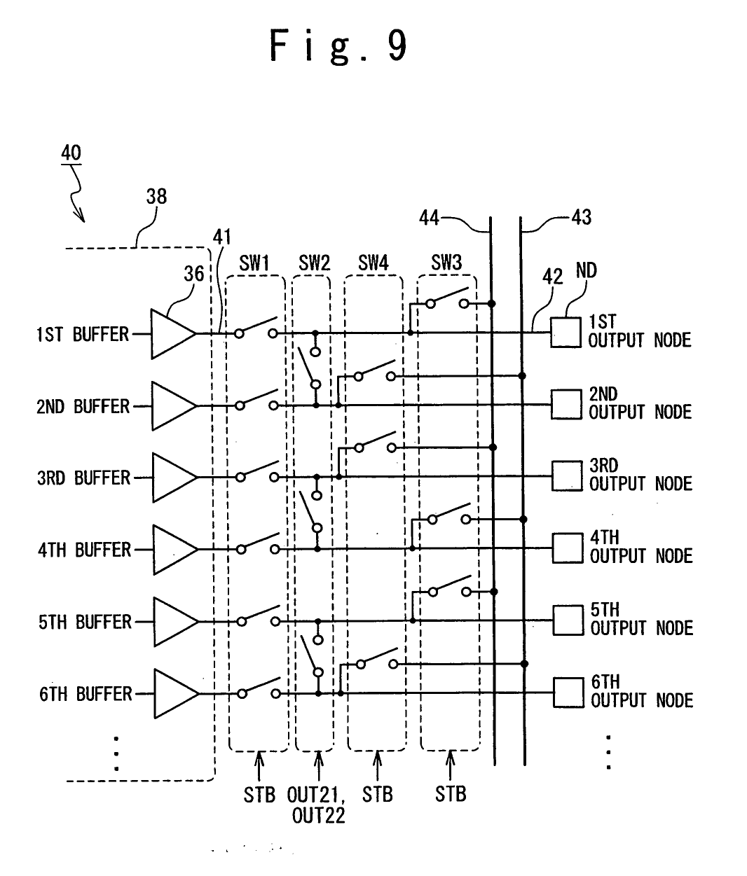

Furthermore, as shown in FIG. 9, in a case of two-dot inversion, the first group of data lines includes first, third, fifth, eighth, ninth, . . . data lines, and the second group of data lines is second, fourth, sixth, seventh, tenth, eleventh, . . . data lines.

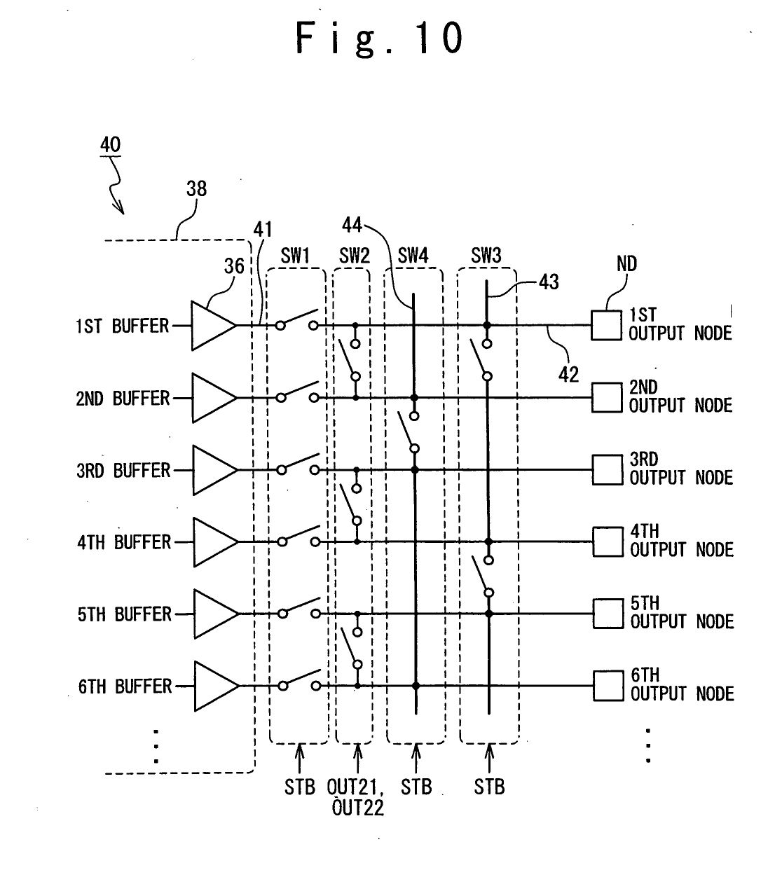

Moreover, as shown in FIG. 10, even in a case of the two-dot inversion, the plurality of switches SW3 and the plurality of switches SW4 can be provided on the short-circuit interconnections 43 and 44, respectively.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A driver comprising:
a gradation voltage supplying section configured to supply a first output gradation voltage to a data line in a first display period;
wherein a first voltage is a common voltage between said first output gradation voltage and a second output gradation voltage of a polarity opposite to that of said first output gradation voltage; and
a charge share performing section configured to supply a second voltage between said first output gradation voltage and said first voltage to said data line in a charge share period after the first display period.

2. The driver according to claim 1, further comprising:
an instructing section configured to output one of a first control signal for a first driving system and a second control signal for a second driving system,
wherein in the first driving system, said gradation voltage supplying section supplies said first output gradation voltage to the data line in the first display period and supplies said second output gradation voltage to the data line in a second display period next to the first display period, and said charge share performing section supplies said first voltage to the data line in the charge share period between the first display period and the second display period; and
wherein in the second driving system, said gradation voltage supplying section supplies said first or second output gradation voltage to the data line in the first display period and the second display period, and said charge share performing section supplies said second voltage to the data line in the charge share period.

3. The driver according to claim 2, wherein said gradation voltage supplying section supplies said first and second output gradation voltages to first and second groups of data lines of a plurality of said data lines in the first display period in response to the first control signal, respectively, and supplies said second and first output gradation voltages to said first and second groups of data lines in the second display period in response to the first control signal, respectively,
wherein said gradation voltage supplying section supplies said first and second output gradation voltages to said first and second groups of data lines in the first and second display periods in response to the second control signal, respectively, and
wherein said charge share performing section supplies said first voltage to said first and second groups of data lines in the charge share period in response to the first control signal, and supplies said second voltage to said first and second groups of data lines in the said charge share period in response to the second control signal.

4. The driver according to claim 3, wherein said charge share performing section comprises:
a first switch section configured to connect said gradation voltage supplying section and said plurality of data lines in the first and second display periods, and disconnect said gradation voltage supplying section from said plurality of data lines in the charge share period;
a second switch section configured to connect said first group of data lines group and said second group of data lines in the charge share period in response to the first control signal;
a third switch section configured to connect the data lines of said first group to each other in the charge share period; and
a fourth switch section configured to connect the data lines of said second group to each other in the charge share period.

5. The driver according to claim 4, wherein said third switch section connects the data lines of said first group to each other via a first short-circuit interconnection in the charge share period, and
wherein said fourth switch section connects the data lines of said second group to each other via a second short-circuit interconnection in the charge share period.

6. The driver according to claim 4, wherein said third switch section directly connects the data lines of said first group to each other in the charge share period, and
wherein said fourth switch section directly connects the data lines of said second group to each other in the charge share period.

7. The driver according to claim 3, wherein said first group is of odd-numbered data lines, and said second group is of even-numbered data lines.

8. The driver according to claim 2, wherein said instructing section outputs the first or second control signal based on a specification.

9. A display apparatus comprising:
a driver; and
a display section,
wherein said driver comprises:
a gradation voltage supplying section configured to supply a first output gradation voltage to a data line in a first display period, wherein the data line is connected to said display section;
wherein a first voltage is a common voltage between said first output gradation voltage and a second output gradation voltage of a polarity opposite to that of said first output gradation voltage; and
a charge share performing section configured to supply a second voltage between said first output gradation voltage and said first voltage to said data line in a charge share period after the first display period.

10. The display apparatus according to claim 9, wherein said driver further comprises:
an instructing section configured to output one of a first control signal for a first driving system and a second control signal for a second driving system,
wherein in the first driving system, said gradation voltage supplying section supplies said first output gradation voltage to the data line in the first display period and supplies said second output gradation voltage to the data line in a second display period next to the first display period, and said charge share performing section supplies said first voltage to the data line in the charge share period between the first display period and the second display period; and
wherein in the second driving system, said gradation voltage supplying section supplies said first or second output gradation voltage to the data line in the first display period and the second display period, and said charge share performing section supplies said second voltage to the data line in the charge share period.

11. The display apparatus according to claim 10, wherein said gradation voltage supplying section supplies said first and second output gradation voltages to first and second groups of data lines of a plurality of said data lines in the first display period in response to the first control signal, respectively, and supplies said second and first output gradation voltages to said first and second groups of data lines in the second display period in response to the first control signal, respectively,
wherein said gradation voltage supplying section supplies said first and second output gradation voltages to said first and second groups of data lines in the first and second display periods in response to the second control signal, respectively, and
wherein said charge share performing section supplies said first voltage to said first and second groups of data lines in the charge share period in response to the first control signal, and supplies said second voltage to said first and second groups of data lines in the said charge share period in response to the second control signal.

12. The display apparatus according to claim 11, wherein said charge share performing section comprises:
a first switch section configured to connect said gradation voltage supplying section and said plurality of data lines in the first and second display periods, and disconnect said gradation voltage supplying section from said plurality of data lines in the charge share period;
a second switch section configured to connect said first group of data lines group and said second group of data lines in the charge share period in response to the first control signal;
a third switch section configured to connect the data lines of said first group to each other in the charge share period; and
a fourth switch section configured to connect the data lines of said second group to each other in the charge share period.

13. The display apparatus according to claim 12, wherein said third switch section connects the data lines of said first group to each other via a first short-circuit interconnection in the charge share period, and
wherein said fourth switch section connects the data lines of said second group to each other via a second short-circuit interconnection in the charge share period.

14. The display apparatus according to claim 12, wherein said third switch section directly connects the data lines of said first group to each other in the charge share period, and
wherein said fourth switch section directly connects the data lines of said second group to each other in the charge share period.

15. The display apparatus according to claim 11, wherein said first group is of odd-numbered data lines, and said second group is of even-numbered data lines.

16. The display apparatus according to claim 10, wherein said instructing section outputs the first or second control signal based on a specification.

17. A driving method comprising:
supplying a first output gradation voltage to a data line in a first display period, wherein a first voltage is a common voltage between said first output gradation voltage and a second output gradation voltage of a polarity opposite to that of said first output gradation voltage; and
supplying a second voltage between said first output gradation voltage and said first voltage to the data line in a charge share period after the first display period.

18. The driving method according to claim 17, further comprising:
outputting one of a first control signal for a first driving system and a second control signal for a second driving system,
wherein said supplying a first output gradation voltage comprises:
supplying said first output gradation voltage to the data line in the first display period in said first driving system; and
supplying said second output gradation voltage to the data line in a second display period next to the first display period in said first driving system,
wherein said supplying a second voltage comprises:
supplying said first voltage to the data line in the charge share period between said first and second display periods in said first driving system,
wherein said supplying a first output gradation voltage comprises:
supplying said first and second output gradation voltages to the data line in the first and second display periods in said second driving system, respectively, and
wherein said supplying a second voltage comprises:
supplying said second voltage to the data line in the charge share period in said second driving system.
